(19) United States
(12) Patent Application Publication
(10) Pub. No.: US 2010/0217687 A1
(43) Pub. Date: Aug. 26, 2010

(54) WEB-BASED AUCTION SYSTEM

(75) Inventor: Larry Garafola, Neshanic Station, NJ (US)

Correspondence Address: JOHN F. LETCHFORD, ARCHER & GREINER, P.C., ONE CENENNIAL SQUARE, HADDONFIELD, NJ, 08033, US

(73) Assignee: EQUIPEMENTFACTS, LLC, Hillsborough, NJ (US)

(21) Appl. No.: 12/709,650

(22) Filed: Feb. 22, 2010

Related U.S. Application Data
(60) Provisional application No. 61/154,583, filed on Feb. 23, 2009.

(51) Int. Cl. G06Q 30/00; G06F 15/16

(52) U.S. Cl. 705/27; 709/206

(57) ABSTRACT

An auctioneer-led virtual auction which takes place entirely on the World Wide Web. There is no physical auction site, there are no bidders physically in the presence of the auctioneer and the items up for auction remain in the possession of their sellers. The items for sale are located at its/their respective locations, the auctioneer is located at a location different from the items for sale and the bidders are located at locations different from the items for sale and the auctioneer. The auctioneer is connected to the virtual auction via either a telephone or an Internet-connected computer and calls out the bidding as he or she monitors the virtual auction.

### CROSS REFERENCE TO RELATED APPLICATION

This application claims the benefit of U.S. Provisional Application No. 61/154,583, filed Feb. 23, 2009.

### FIELD OF THE INVENTION

The present invention relates in general to Web-based auction systems and in particular to a Web-based auction system that employs a human auctioneer in the auction process.

### BACKGROUND OF THE INVENTION

Published U.S. Patent Application No. 2006/0206408 discloses a Web-based auction system that utilizes an animated character in lieu of a human auctioneer. Similarly, Published U.S. Patent Application No. 2009/0006221 discloses an online auction which is hosted or led by an animated auction “attendant”. An obvious disadvantage of these sorts of auction systems is that they eliminate all human involvement on the “sell” side of the auction process. That is, they dehumanize the auction experience for those who appreciate the human interaction of a conventional auction led by a human auctioneer.

U.S. Pat. Nos. 6,415,269; 6,813,612 and 7,428,501 and Published U.S. Patent Application Nos. 2005/0246266; 2007/0214074 and 2008/0235115 provide online systems and methods for auctioning goods in real-time from a remote auction site. The auction is hosted or led by a human auctioneer conducting a live auction at the remote site. Live video and/or audio feeds of the auction are received at a bidder's computer, thereby giving the bidder a sense of attending the remote live auction. The bidder is apprised at all times of the current bid price and may bid against others in actual attendance at the auction site. A deficiency of this sort of system is that, although a human auctioneer is involved in the process, the auctioneer must be located at the auction site in order to conduct the auction. This requires retaining the services of an auctioneer at each auction location. However, auctioneer fees and service quality of may vary considerably from auction site to auction site. In addition, similar to conventional “offline” auctions, both indoor and outdoor auctioneer-led auctions may be impacted by inclement weather or other unexpected events which may cause postponement or cancellation of the auctions. Further, while online auction participants experience some sensation similar to attending a live auction by monitoring a video and/or audio feed of the auction, online bidders do not experience the same level of involvement as, and may thus be at a disadvantage relative to, their on-site counterparts.

Published U.S. Patent Application Nos. 2005/0216355; 2005/0216392; 2005/0234813 and 2008/0306836 disclose systems and methods for conducting a remote auction via the use of at least one auction agent that can proficiently fetch optimum prices for goods bought or sold on behalf of buyers or sellers.

U.S. Pat. No. 7,617,145 discloses a system and method for the conduct of an online auction in which bidders are able to place bids on lots in the auction by selecting from a plurality of predetermined bid increments provided by the system. The predetermined bid increments provided by the system are adjusted during the auction of a specific lot to adapt to sale conditions and maximize the price obtained at auction.

U.S. Pat. Nos. 7,577,676 and 7,403,915 respectively disclose systems and methods for interactive television and interactive Internet auctions wherein a bidder may participate in an auction via telephone or through Internet input means. There is no auctioneer involvement in the processes. Accordingly, the participant does not experience the sensation of a conventional auctioneer-led auction.

Published U.S. Patent Application No. 2009/0012878 discloses a system and method for posting an item for sale on the Internet. In addition to other features, a verbal description file of the item is posted along with other files related to the item. However, there is no auctioneer involvement in the processes.

An advantage exists, therefore, for a Web-based, auctioneer-led auction system and method which provides all potential bidders with an equal sense of participation or involvement in the auction process.

A further advantage exists for a Web-based, auctioneer-led auction system and method which minimizes the likelihood of auction postponement or cancellation.

A further advantage exists for a Web-based, auctioneer-led auction system and method which eliminates the need to retain different auctioneers for different auction events.

### SUMMARY OF THE INVENTION

The present invention provides an auctioneer-led virtual auction system and method which takes place solely on the World Wide Web. There is no physical auction site. The items for sale are located at its/their respective locations, the auctioneer is located at a location different from the items for sale and the bidders are located at locations different from the items for sale and the auctioneer. There are no bidders physically in the presence of the auctioneer, and the items up for auction remain in the possession of their sellers. The auction includes an auctioneer connected to the virtual auction via either a telephone or an Internet-connected computer whereby the auctioneer calls out the bidding as he or she monitors the virtual auction. The auction also preferably additionally includes the use of photographs and/or pre-recorded video clips of the items up for auction. Each item desirably has a complete description including, inter alia and as appropriate, its location, shipping requirements, removal requirements and loading times.

Although not limited thereto, the system is useful for auctioning heavy equipment, motor vehicles and the like. Heretofore, auctions of such items were typically conducted outdoors or in large indoor venues, hence they suffered from the shortcomings of the live and Internet, i.e., Web-based, auctions discussed above. The present auction system and method overcomes those deficiencies.

Other details, objects and advantages of the present invention will become apparent as the following description of the presently preferred embodiments and presently preferred methods of practicing the invention proceeds.

### BRIEF DESCRIPTION OF THE DRAWINGS

The invention will become more readily apparent from the following description of preferred embodiments thereof shown, by way of example only, in the accompanying drawings wherein:

FIG. 1 is a schematic view of a Web-based auction system in accordance with the present invention;

FIG. 2 is a screen shot of a website implementing a Web-based auction system according to the invention; and

FIG. 3 is a screen shot of a website showing a sale catalog entry of a Web-based auction system according to the invention.

### DETAILED DESCRIPTION OF THE INVENTION

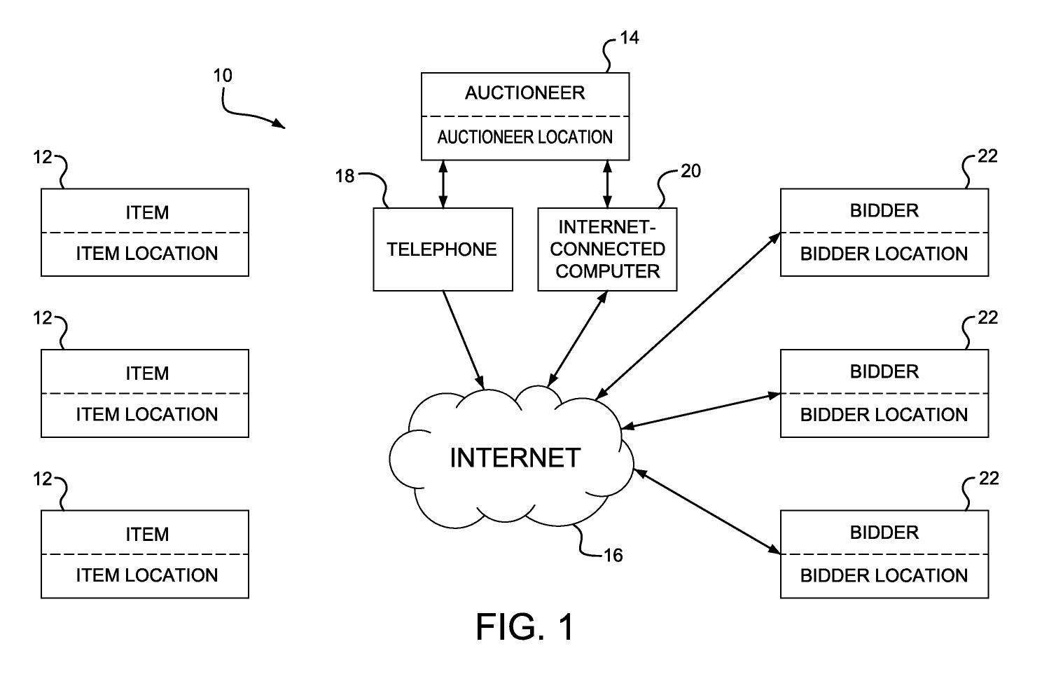

Referring to the drawings, wherein like or similar references indicate like or similar elements throughout the several views, there is shown in FIG. 1 a Web-based auction system identified generally by reference numeral 10.

System 10 comprises at least one item 12 for sale. Each item has its own respective item location. As used herein the term “item” shall mean any good or service that may be capable of being sold by virtual auction. Additionally, the term “lot” shall mean an auction unit comprising at least one item. System 10 further includes a human auctioneer 14 located at a location different from each of the locations of the lots or item(s) being offered for sale. The human auctioneer 14 is connected to the Internet 16 via telephone 18 or Internet-connected computer 20 whereby the auctioneer calls out the bidding as he or she monitors the virtual auction. Lastly, system 10 includes one or more bidders 22 each having bidder locations different from the locations of both the items 10 and the auctioneer 14. The bidder(s) 22 communicate with the auctioneer 14 via the Internet 16 to bid on one or more item(s) 12.

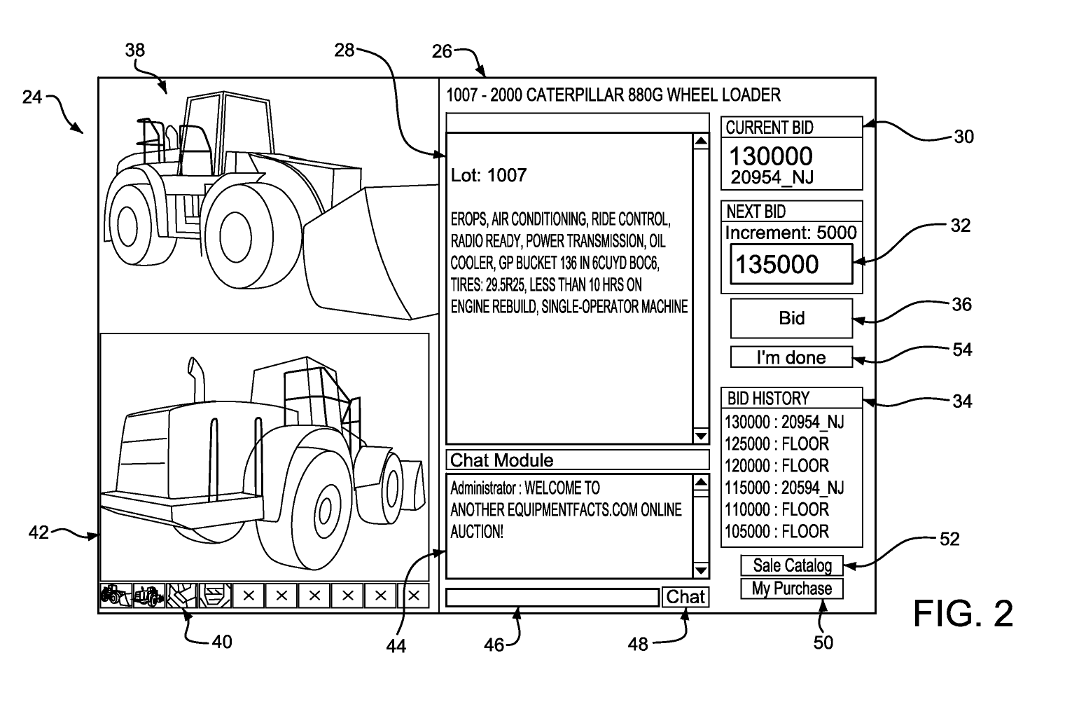

Referring to FIG. 2, there is shown a website screen shot 24 of a Web-based auction system according to the invention which serves as means for enabling online auctioning of at least one item. It will be understood that a greater or lesser number of features than those depicted in screen shot 24 may be incorporated into a Web-based auction system and method according to the invention without departing in spirit or scope from the present invention.

By way of example, system 10 (as manifested by screen 24) includes the number and title 26 of the current lot or item(s) being sold. It will be understood that a particular lot may include more than one item for sale. Screen 24 further includes a lot description 28 which preferably displays the current lot number and a description of the item(s) included in the lot for sale. Box 30 displays the current bid, box 32 the next or “asking” bid and box 34 displays the bid history for the lot, preferably including identification of the bidders and their bids. Bid button 36 allows the bidder to electronically place the current asking bid with the auctioneer.

Screen 24 may include a live video feed 38 of the auction (it will be understood that a live video feed may not be available at all auctions). Also desirably included are one or more selectable thumbnail images 40 of the lot or item for sale, the enlarged version of a selected thumbnail image being displayed in window 42.

Screen 24 also desirably includes a chat module 44 by which a bidder and an auction administrator may exchange messages. Using chat module 44 a bidder may communicate essentially in real-time with an auction administrator about any topic associated with the auction, including, without limitation, past, present and future lots/items for sale. In this regard, system 44 preferably includes a chat box 46 into which a bidder enters messages for the auction administrator and a “Chat” button 48 the clicking of which sends a message from the bidder to the auction administrator.

Screen 24 further includes a “My Purchase” button 50. Clicking of this button opens a new window (not illustrated) which displays the lot(s) the bidder has purchased (subject to confirmation by the auctioneer). Relatedly, screen 24 also preferably has a “Sale Catalog” button 52 which, if clicked, opens a new window (also not illustrated) that may display, inter alia, the complete catalog of the auction that the bidder is monitoring. Lastly, screen 24 includes an “I'm done”, “Quit” or similar button 54 that the bidder clicks when he or she desires to end a bidding session.

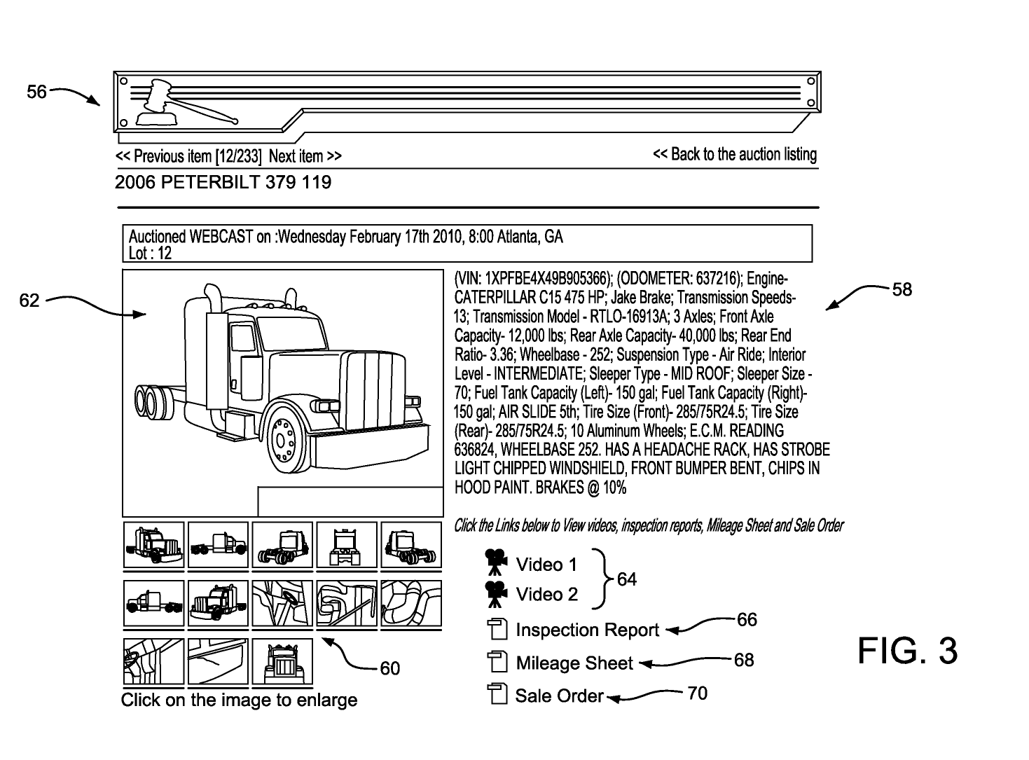

FIG. 3 displays a website screen 56 showing a sale catalog entry of a Web-based auction system according to the invention. More particularly, FIG. 3 displays certain details of one lot up for sale at auction. As illustrated in FIG. 3, the lot for sale is a tractor-trailer truck. It will be understood, however, that the lot may be from another category of heavy equipment or may be any other type of item or service that lends itself to being sold online via an auctioneer-led auction.

Similar to screen 24, screen 56 desirably includes a lot description 58 and one or more selectable thumbnail images 60 of the lot or item(s) for sale, wherein an enlarged version of a selected thumbnail image is displayed in window 62. Screen 56 also preferably includes one or more links to such modules as videos 64 of the lot for sale, an inspection report 66 for the lot (which is useful for motor vehicles), a mileage sheet 68 (also useful for motor vehicles) and the sale order 70. It will be understood that information germane to the particular item(s) being sold, other than inspection reports, mileage sheets or other information uniquely pertinent to motor vehicles, heavy equipment or the like, may be provided on screen 56. By way of example but not limitation, screen 56 may include appraisals or other reports where such information may be of relevance, e.g., for fine jewelry and other real or personal property. Also, either or both of screens 24 and 56 may include, inter alia and as appropriate, the location, shipping requirements, removal requirements and loading times of the item(s) advertised in a lot for sale.

The present system and method places all bidders on an equal footing in a human auctioneer-led auction. That is, because there is no actual auction site and because all bidders participate online, there are no bidders live at an auction site who might be at a competitive advantage relative to their online counterparts. Furthermore, there is no need to hire different auctioneers for items located in different physical, i.e., geographical, locations since all auctions may be led by a single, remotely-located auctioneer. Thus, the quality and cost of the auctioneer may be readily controlled. Moreover, since there are no live auction sites, the possibility that an auction may be postponed or cancelled due to inclement weather or other unforeseen circumstances is greatly reduced.

Although the invention has been described in detail for the purpose of illustration, it is to be understood that such detail is solely for that purpose and that variations can be made therein by those skilled in the art without departing from the spirit and scope of the invention as claimed herein.

What is claimed is:

1. A method for conducting a Web-based auction comprising the steps of:
(a) providing at least one item to be sold at auction, wherein the at least one item is located at least one item location;
(b) providing Web-based means for enabling online auctioning of the at least one item;
(c) providing a human auctioneer for conducting an auction of the at least one item, wherein the human auctioneer is in communication with said Web-based means and is located at an auctioneer location different from said at least one item location.

2. The method of claim 1 wherein bidders participating in the auction are located at bidder locations different from said at least one item location and said auctioneer location.

3. The method of claim 1 further comprising displaying by said Web-based means a current lot number and a description of at least one item included in a lot for sale.

4. The method of claim 1 further comprising providing a video feed of at least one item included in a lot for sale using said Web-based means.

5. The method of claim 1 further comprising providing a chat module using said Web-based means.

6. The method of claim 1 further comprising providing a bid history display using said Web-based means.

7. A Web-based auction system for selling at least one item at auction wherein the at least one item is located at at least one item location, the system comprising:
Web-based means for enabling online auctioning of the at least one item;
a human auctioneer for conducting an auction of the at least one item; and
means for communicating the human auctioneer with said Web-based means, wherein the human auctioneer is located at an auctioneer location different from the at least one item location.

8. The system of claim 7 wherein bidders participating in the auction are located at bidder locations different from said at least one item location and said auctioneer location.

9. The system of claim 7 wherein said Web-based means comprise a website including a lot description displaying a current lot number and a description of at least one item included in a lot for sale.

10. The system of claim 7 wherein said Web-based means comprise a website including a video feed of at least one item included in a lot for sale.

11. The system of claim 7 wherein said Web-based means comprise a website including a chat module.

12. The system of claim 7 wherein said Web-based means comprise a website including a bid history display.
